(19) United States
(12) Patent Application Publication
(10) Pub. No.: US 2019/0325488 A1
(43) Pub. Date: Oct. 24, 2019

(54) INTERACTIVE REAL-TIME CLOUD-BASED REVIEW SYSTEM

(71) Applicants: Xiufang Xie, Fremont, CA (US); Laurent Nguyen, San Jose, CA (US); C. Douglass Thomas, Saratoga, CA (US)

(72) Inventors: Xiufang Xie, Fremont, CA (US); Laurent Nguyen, San Jose, CA (US); C. Douglass Thomas, Saratoga, CA (US)

(21) Appl. No.: 16/219,942

(22) Filed: Dec. 14, 2018

Related U.S. Application Data
(60) Provisional application No. 62/661,620, filed on Apr. 23, 2018.

(51) Int. Cl. G06Q 30/02; H04L 12/58; G06F 16/23; G06F 16/9035; G06F 16/955; H04M 15/00

(52) U.S. Cl. CPC G06Q 30/0282; H04L 51/046; H04M 15/755; G06F 16/9035; G06F 16/955; G06F 16/23

(57) ABSTRACT

An interactive cloud-based review system that can support reviews of providers (e.g., service providers) using unique identifiers, such as phone numbers. The providers can pertain to persons (e.g., sole proprietors) or businesses. Users (customers or clients of providers) can interact with the interactive cloud-based review system using stationary or mobile electronic computing devices operating a general messaging application, a custom review application, or a network browser application. In one embodiment, providers can be identified by their phone numbers, and reviews can be correlated to such phone numbers. The phone numbers utilized are often mobile phone numbers. Advantageously, by providing reviews of providers, those clients or customers that are dissatisfied with the services rendered are able to release some frustrations. Also, clients or customers that are satisfied with the services rendered can offer accolades for the provider.

### CROSS-REFERENCE TO RELATED APPLICATION

This application claims priority to U.S. Provisional Application No. 62/661,620, filed Apr. 23, 2018, and entitled “INTERACTIVE REAL-TIME CLOUD-BASED REVIEW SYSTEM,” which is hereby incorporated by reference herein in its entirety for all purposes.

### BACKGROUND

Customers of service providers often have an opinion of the services provided by the service providers. Conventional solutions allow customers to review or provide feedback to be made to certain businesses. One example of a conventional solution is yelp (www.yelp.com), which allows a user to search for a business and write a review. However, to do so, the business must first be setup or registered with the yelp system. Unfortunately, however, many small business are not in such systems and, therefore, unable to be reviewed. Additionally, the reviews are largely unstructured, often lengthy, and overall cumbersome to access and evaluate.

There remains a need for improved approaches to enable users to more efficiently access review information for service providers.

### SUMMARY

An interactive cloud-based review system that can support reviews of providers (e.g., service providers) using unique identifiers, such as phone numbers, is disclosed. The providers can pertain to persons (e.g., sole proprietors) or businesses. Users (customers or clients of providers) can interact with the interactive cloud-based review system using stationary or mobile electronic computing devices operating a general messaging application, a custom review application, or a network browser application. In one embodiment, providers can be identified by their phone numbers, and reviews can be correlated to such phone numbers. The phone numbers utilized are, for example, mobile phone numbers. Advantageously, by providing reviews of providers, those clients or customers that are dissatisfied with the services rendered are able to release some frustrations. Also, clients or customers that are satisfied with the services rendered can offer accolades for the provider.

Users can interact with the interactive cloud-based review system using a simplified user interface, such that not only can a review for an identified provider be produced and submitted with little time and effort, but also prior reviews of an identified provider can be likewise retrieved and presented to a requester rapidly (i.e., in near real-time) and with little effort. The simplified user interface can be a text message interface, an app interface, or a website interface, depending on implementation.

A database can be utilized to provide for technology efficient storage and retrieval of reviews. The database can be organized and configured to store review data correlated to provider numbers.

In another embodiment, providers (e.g., businesses) can be identified by their website domain name. The interactive cloud-based review system can support submission and retrieval of reviews of providers that are correlated to such domain names. Hence, any of the processing described above can utilize a domain name as opposed to a phone number to identify a provider.

Embodiments of the invention can be implemented in numerous ways, including as a method, system, device, or apparatus (including graphical user interface and computer readable medium). Several embodiments of the invention are discussed below.

As a method for processing a review request for storage in a database, one embodiment can, for example, include at least: receiving a review request from a reviewer, the reviewer having a reviewer phone number associated with the reviewer, the review request including a provider phone number associated with a provider; extracting the reviewer phone number and the provider phone number from the review request; accessing the database to retrieve eligibility data for the reviewer with regard to the provider phone number; determining whether the reviewer is eligible to review the provider associated with the provider phone number based on the eligibility data; forming a review creation response for the reviewer if the determining determines that the reviewer is eligible to review the provider; transmitting the review creation response to the reviewer; subsequently receiving a review submission response from the reviewer, the review submission response being in response to the review creation response, the review submission response providing the review of the provider by the reviewer, and the review submission response including review data for the review; and accessing the database to update the database to at least include the review data for the review of the provider by the reviewer.

As a method for processing a review request for storage in a database, one embodiment of the invention can, for example, include at least: receiving a review request from a reviewer, the reviewer having a reviewer phone number associated with the reviewer, the review request including (i) a provider phone number associated with a provider and (ii) a provider classification; extracting the reviewer phone number, the provider phone number and the provider classification from the review request; forming a review creation response for the reviewer dependent on the provider classification of the provider; transmitting the review creation response to the reviewer; subsequently receiving a review submission response from the reviewer, the review submission response being in response to the review creation response, the review submission response providing the review of the provider by the reviewer, and the review submission response including review data for the review; and accessing the database to update the database to at least include the review data for the review of the provider by the reviewer.

As a method for accessing information pertaining to a service provider, one embodiment of the invention can, for example, include at least: electronically receiving an inquiry submission from a requestor, the inquiry submission being initiated by the requestor via a network, the inquiry submission including a telephone number associated with a service provider; accessing a provider database using the telephone number to retrieve access data for retrieval of provider review information pertaining to the service provider; retrieving the provider review information pertaining to the service provider using the access data; and electronically transmitting the provider review information to the requestor.

As a method for accessing information pertaining to a provider, one embodiment can, for example, include at least: electronically receiving an inquiry submission from a requestor, the inquiry submission being initiated by the requestor via a network, the inquiry submission including a telephone number associated with a provider; accessing a provider database using the telephone number to retrieve provider review information pertaining to the provider; formatting the provider review information into a response; and electronically transmitting the response to the requestor.

As a method for accessing information pertaining to a provider, one embodiment can, for example, include at least: electronically receiving an inquiry submission from a requestor, the inquiry submission being initiated by the requestor via a network, the inquiry submission including a telephone number associated with the provider; accessing a provider database using the telephone phone number associated with the provider to retrieve a provider page identifier; retrieving a provider review page or a cloud-based link thereto based on the provider page identifier, the provider review page including a review summary for the provider and a plurality of reviews of the provider; and initiating electronic transmission of the provider review page or the cloud-based link thereto to the requestor.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a provider review system according to one embodiment.

FIG. 2 is a block diagram of a provider review system according to one embodiment.

FIG. 3 is a schematic diagram of a data layout structure according to one embodiment.

FIG. 4 is a flow diagram of a review access process according to one embodiment.

FIGS. 5A and 5B are flow diagrams of a review submission request process according to one embodiment.

FIG. 5C is a flow diagram of an additional process according to one embodiment.

FIGS. 6A and 6B are flow diagrams of a review submission request process according to one embodiment.

FIG. 7 is a flow diagram of a provider review page generation process according to one embodiment.

FIG. 8 is a flow diagram of a top provider process according to one embodiment.

FIG. 9 is an exemplary screen of a base review user interface.

FIG. 10 is an exemplary screen of a make review user interface.

FIG. 11A is an exemplary screen of a provider review user interface.

FIG. 11B is another exemplary screen of a provider review user interface.

FIG. 11C is yet another exemplary screen of a provider review user interface.

FIG. 12 is an exemplary screen of a provider find user interface.

FIG. 13 is an exemplary screen of a business review user interface.

FIG. 14 is an exemplary screen of a business review user interface.

FIGS. 15A-15W are exemplary screens of text-messages providing user interfaces for a provider review system according to certain embodiments.

FIG. 16 shows an exemplary computer system.

### DETAILED DESCRIPTION OF EMBODIMENTS OF THE INVENTION

An interactive cloud-based review system that can support reviews of providers (e.g., service providers) using unique identifiers, such as phone numbers, is disclosed. The providers can pertain to persons (e.g., sole proprietors) or businesses. Users (customers or clients of providers) can interact with the interactive cloud-based review system using stationary or mobile electronic computing devices operating a general messaging application, a custom review application, or a network browser application. In one embodiment, providers can be identified by their phone numbers, and reviews can be correlated to such phone numbers. The phone numbers utilized are often mobile phone numbers. Advantageously, by providing reviews of providers, those clients or customers that are dissatisfied with the services rendered are able to release some frustrations. Also, clients or customers that are satisfied with the services rendered can offer accolades for the provider.

Users can interact with the interactive cloud-based review system using a simplified user interface, such that not only can a review for an identified provider be produced and submitted with little time and effort, but also prior reviews of an identified provider can be likewise retrieved and presented to a requester rapidly (i.e., in near real-time) and with little effort . The simplified user interface can be a text message interface, an app interface, or a website interface, depending on implementation.

A database can be utilized to provide for technology efficient storage and retrieval of reviews. The database can be organized and configured to store review data correlated to provider numbers.

In another embodiment, providers (e.g., businesses) can be identified by their website domain name. The interactive cloud-based review system can support submission and retrieval of reviews of providers that are correlated to such domain names.

The various aspects, features, embodiments or implementations of the invention described above can be used alone or in various combinations.

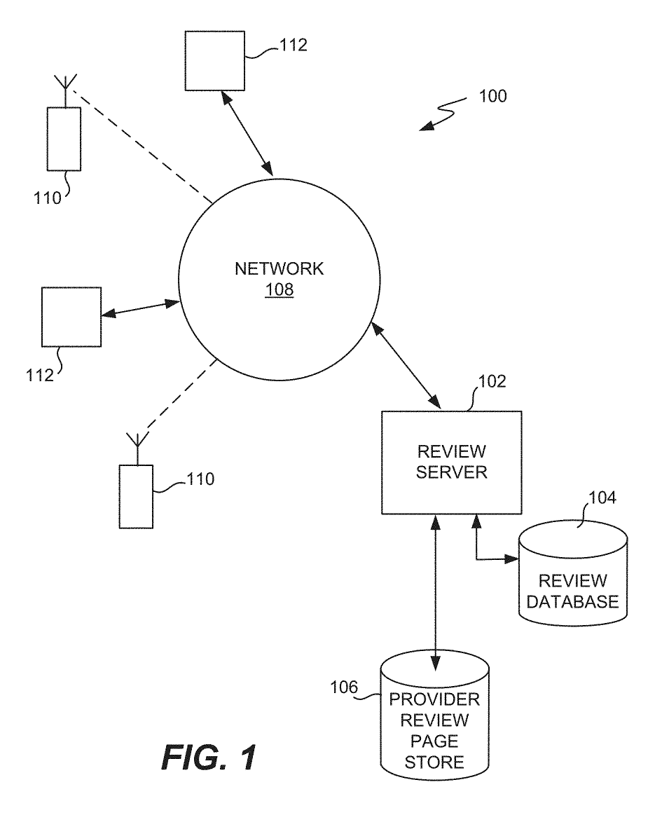

Embodiments of various aspects of the invention are discussed below with reference to FIGS. 1-16. However, those skilled in the art will readily appreciate that the detailed description given herein with respect to these figures is for explanatory purposes as the invention extends beyond these limited embodiments.

FIG. 1 is a block diagram of a provider review system 100 according to one embodiment. The provider review system 100 supports reviews of providers, such as service providers. These reviews can be electronically submitted by clients or customers of the providers. The reviews can be maintained by the provider review system 100 and electronically accessible via one or more networks. As a result, for those providers that have been reviewed by certain clients or customers, other potential clients or customers can access and review these prior reviews before making a decision whether to utilize the providers for services that they offer.

The provider review system 100 includes a review server 102. The review server 102 can provide processing to receive reviews, maintain reviews, and serve reviews. The review server 102 can utilize a review database 104 and a provider review page store 106 that can also be part of the provider review system 100. The review database 104 stores review data pertaining to reviews, information pertaining to providers, information pertaining to reviewers, etc. The provider review page store 106 can store a plurality of different provider review pages that can be accessed and served to requesters that have requested to view available reviews for a given provider.

The provider review system 100 also supports a plurality of customer or client devices 110, 112. The customer or client devices 110, 112 pertain to wireless computing or communication devices, such as smart phones, tablet computers, netbooks, laptops, wearable computing devices (electronic watch, electronic glasses, etc.) and the like. The customer or client devices 112 pertain to wired computing or communication devices, such as a desktop computer or notebook computer. A given customer or client can utilize any of the customer or client devices 110, 112 to access the review server 102 for purposes of either retrieving review data for a given service provider (which can be provided as a provider review page) or submitting a review for a given service provider.

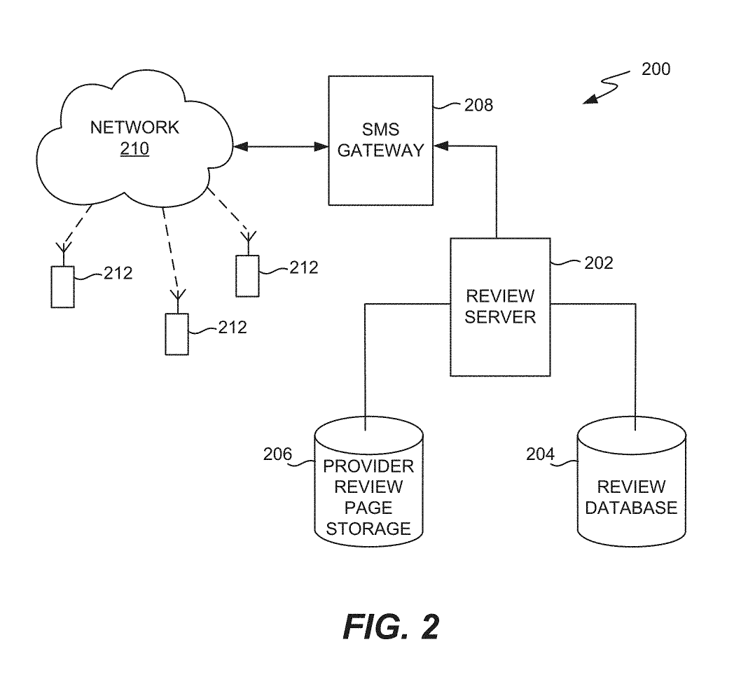

FIG. 2 is a block diagram of a provider review system 200 according to one embodiment. The provider review system 200 supports reviews of providers, such as service providers. These reviews can be electronically submitted by clients or customers of the providers. The reviews can be maintained by the provider review system 200 and electronically accessible via one or more networks. As a result, for those providers that have been reviewed by certain clients or customers, other potential clients or customers can access and review these prior reviews before making a decision whether to utilize the providers for services that they offer. The provider review system 200 is configured to permit clients or customers to utilize text messages, such as a short message service, to submit a review and also to receive previously submitted reviews of a provider.

The provider review system 200 includes a review server 202. The review server 202 can provide processing to receive reviews, maintain reviews, and serve reviews. The review server 202 can utilize a review database 204 and a provider review message store 206 that can also be part of the provider review system 200. The review server 202 can couple to a network via a Short Message Service (SMS) gateway 208. The SMS gateway 208 can permit communications via text messages over a network 210. For example, the network 210 can include a SMS network.

The review database 204 can store review data pertaining to reviews, information pertaining to providers, information pertaining to reviewers, etc. The provider review message store 206 can store a plurality of different provider review messages that can be accessed and served to requesters that have requested to view available reviews for a given provider. The provider review messages stored in the provider review message store 206 can be formatted text messages that are configured to be sendable over the SMS gateway 208. The SMS gateway 208 typically imposes a size limit on text messages being send via the SMS gateway. For a given provider having significant review data, the provider review message store 206 may store such review data as a series of sequential review message parts that can be sequentially provided to the requesting client or customer as text messages. For example, the sequential review message parts can be limited to a given size, such as 250 characters.

The provider review system 200 also supports a plurality of customer or client devices 212. The customer or client devices 212 pertain to wireless computing or communication devices, such as smart phones, tablet computers, netbooks, laptops wearable computing devices (electronic watch, electronic glasses, etc.) and the like, that are configured to support exchange of text messages. A given customer or client can utilize any of the customer or client devices 212 to access the review server 202 for purposes of either retrieving review data for a given service provider (which can be provided as one or a series of text messages) or submitting a review for a given service provider (which can be achieved by one or more text messages).

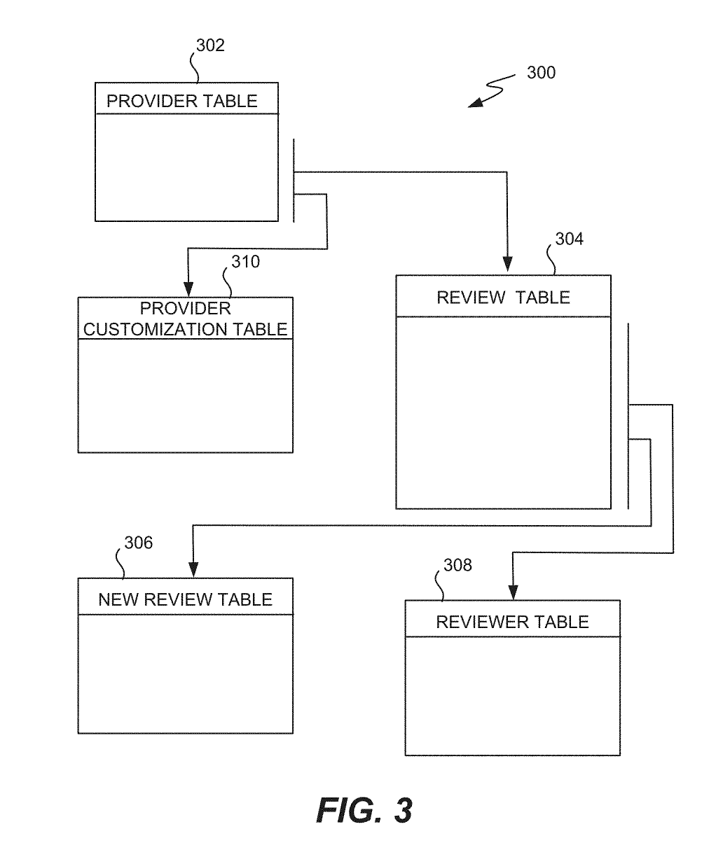

FIG. 3 is a schematic diagram of a data layout structure 300 according to one embodiment. The database layout structure 300 provides an arrangement of database tables to support a provider review system, such as the provider review system 100 illustrated in FIG. 1 or the provider review system 200 illustrated in FIG. 2.

The database layout structure 300 can include a provider table 302 that includes one or more records pertaining to providers that can be reviewed or have been reviewed by the provider review system. The provider table 302 can include descriptive information pertaining to the providers. The descriptive information pertaining to the providers can, for example, include services provided, website address, phone number, awards, certification, marketing, coupons, etc.

The provider table 302 can index into a review table 304. The review table 304 can include one or more records pertaining to one or more reviews of providers. Hence, for a given provider identified in the provider table 302, the corresponding reviews associated with that provider can be linked to and obtained from the review table 304. The review table 304 can also detail characteristics or attributes of the reviews. In one embodiment, the entirety of a review can be stored in the review table 304 as review data. For example, in one implementation, the review data can include data, such as, a rating (e.g., # of stars), quality indication, efficiency indication, price level, recommend (or not recommend), and may also include a provider type indication. Optionally, the review data can further include a narrative or text that is provided by the reviewer. The narrative or text would typically be limited (e.g., to 100, 150 or 250 characters).

Additionally, the review table 304 can link to a new review table 306 and a reviewer table 308. The new review table 306 can serve to identify those reviews that are deemed new. The provider review system can make use of the new review table 306 to determine when to perform processing to obtain an updated or new provider review page so that the provider review pages of various providers can be updated and stored in an efficient manner. Also, the use of provider review pages that are automatically updated is advantageous for efficient serving of review data from a review server to numerous requestors.

The reviewer table 308 can provide descriptive information pertaining to the reviewers. Hence, from the review table 304, for a given review, the review table 304 can link to the corresponding reviewer identified in the reviewer table 308. The reviewer table 308 can provide information concerning reviewers. The information concerning reviewers can, for example, include reviewer's phone number, area code, who and when they have submitted review, and could also include get review search history or find provider search history.

Moreover, the database layout structure 300 can also include a provider customization table 310. For given provider identified in the provider table 302, the provider customization table 300 and can contain customization data for the given provider. The customization data can vary with implementation. However, as examples, the customization data can include provider logo, website link, contact information, services available, hours of operation, accreditations, reviews, awards, coupons, and/or the like.

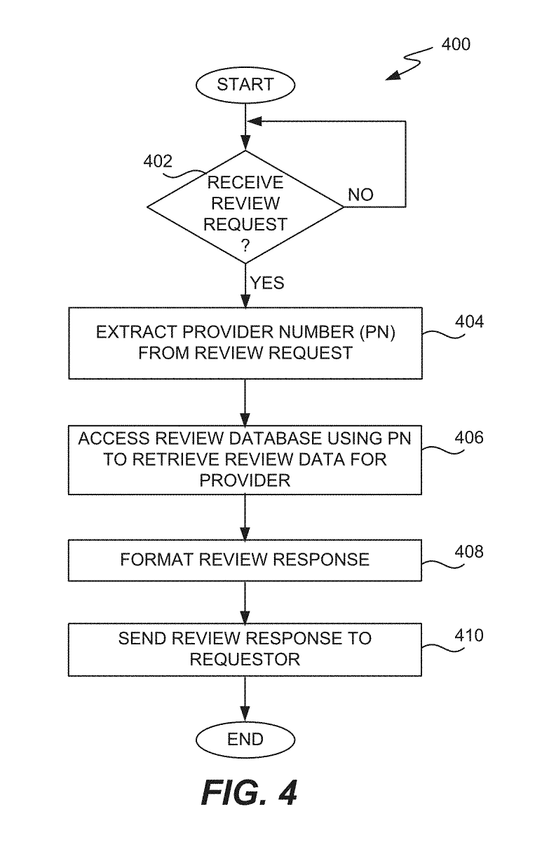

FIG. 4 is a flow diagram of a review access process 400 according to one embodiment. The review access process 400 can, for example, be performed by a review server, such as the review server 102 illustrated in FIG. 1 or the review server 202 illustrated in FIG. 2.

The review access process 400 can begin with a decision 402 that determines whether a review request has been received. When the decision 402 determines that a review request has not been received, then the review access process 400 can await such a request. On the other hand, when the decision 402 determines that a review request has been received, then a provider number (PN) can be extracted 404 from the review request. Next, a review database can be accessed 406 using the PN to retrieve review data for the provider. After the review data for the provider has been accessed 406, a review response can be formatted 408. The formatting of the review response can be assembling a review response from various components or attributes of a review or set of reviews, or can be the formatting of a previously prepared review response for a given recipient device.

In one implementation, the review database contains network identifiers, namely, provider URLs, that can be used to provide previously prepared review responses. As such, using the PN, the corresponding provider URL can be identified from the review database. The provider review, which is typically a page, can then be retrieved using the provider URL. The provider review that has been retrieve can then be formatted 408 for the characteristics of the recipient device.

Following any formatting 408 of the review response, the review response can be sent 410 to the requestor. There are various ways in which the review response can be sent 410 to the requestor. For example, if the review response is sent using a text message, the text message can include a link that can be selected to retrieve the provider review page (e.g., and presented in a network browser). As another example, the review response can be embedded within the text message and if necessary can be distributed over a series of text messages. As still another example, the review response can be presented in an application (i.e., application program or “App”).

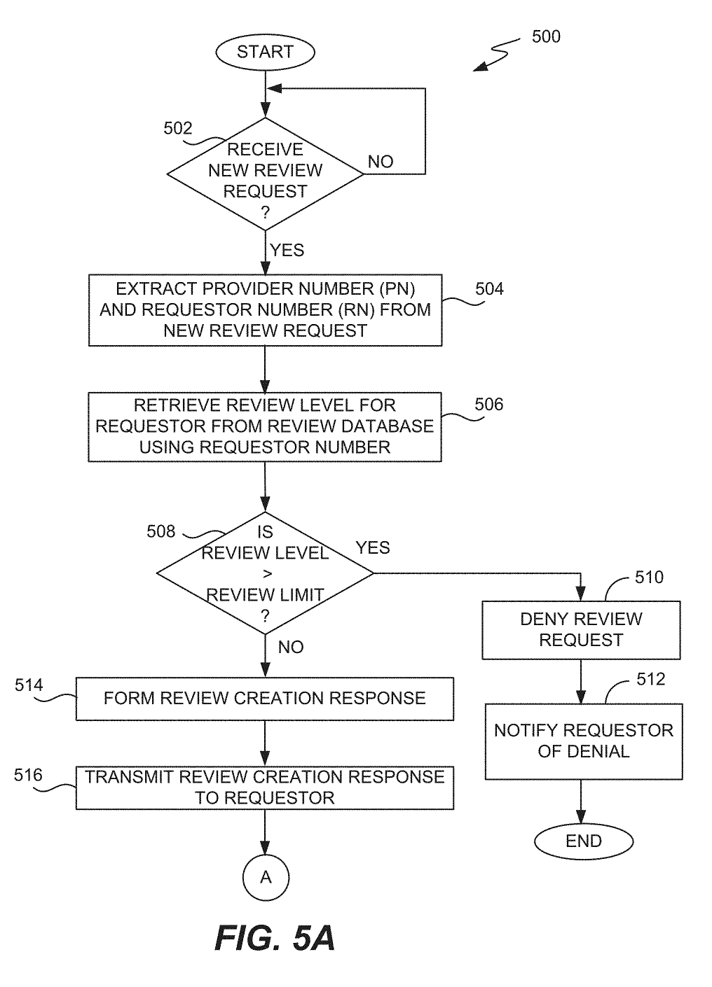

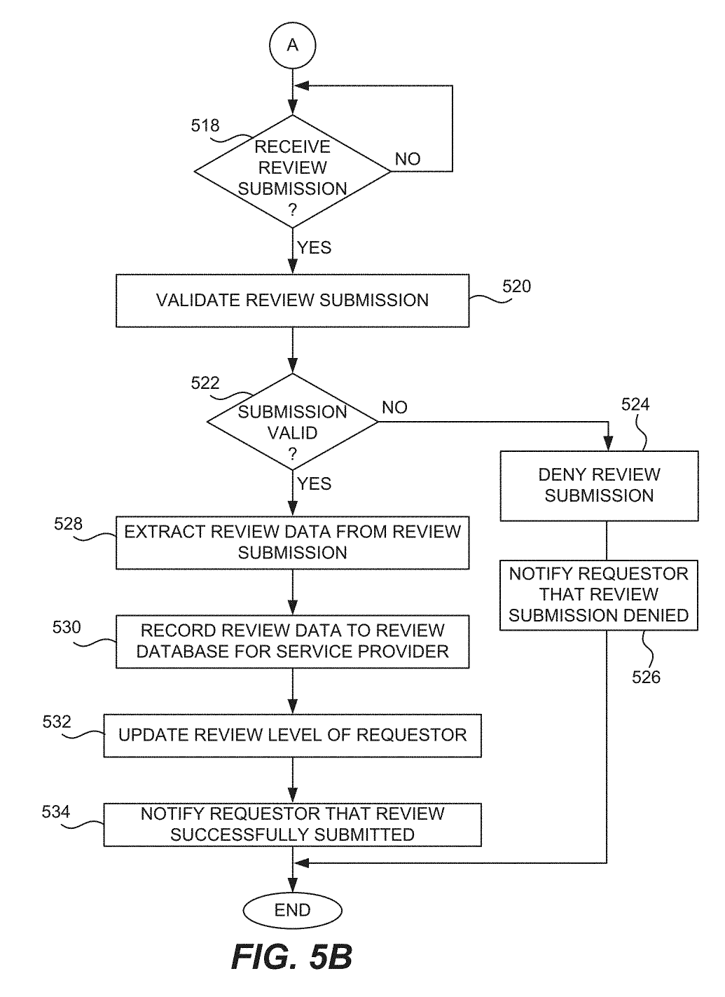

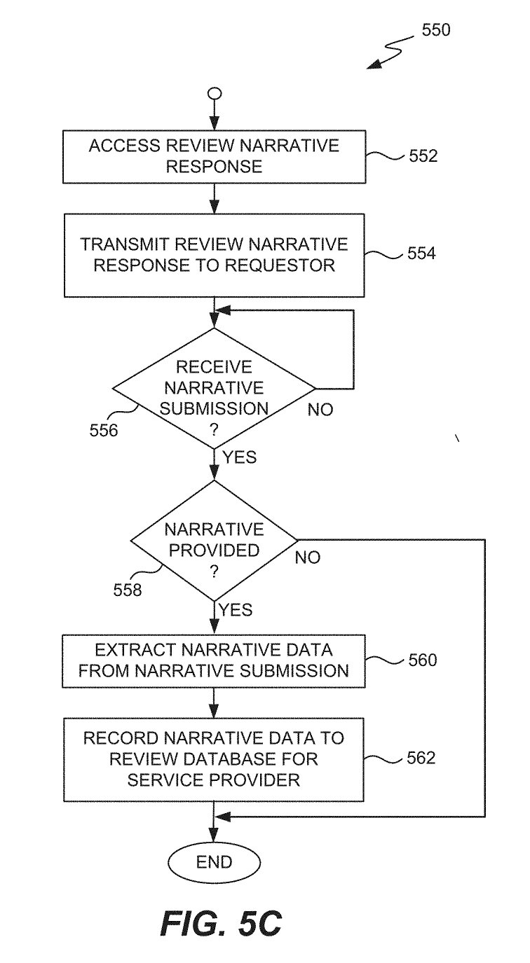

FIGS. 5A and 5B are flow diagrams of a review submission request process 500 according to one embodiment. The review submission request process 500 can, for example, be performed by a review server, such as the review server 102 illustrated in FIG. 1 or the review server 202 illustrated in FIG. 2.

The review submission request process 500 can begin with a decision 502 that determines whether a new review request has been received. When a reviewer submits a review, the review server considers the submission as a new review request. In any event, when the decision 502 determines that a new review request has not been received, the review submission request process 500 can await of such a request.

On the other hand, when the decision 502 determines that a new review request has been received, the review submission request process 500 can continue to perform processing to process the in-take of a review. When the review submission request process 500 continues, a provider number (PN) and a requestor number (RN) can be extracted 504 from the new review request.

Next, a review level for the requestor can be retrieved 506 from a reviewed database using the requestor number (RN). A decision 508 can then determine whether the review level is greater than a review limit. Here, for a given requestor, there can be a review limit that serves to limit the number of reviews the requestor is permitted to submit. In one implementation, the review limit can be generally applicable or applicable to a particular provider. For example, a requestor may be permitted to submit only one (1) review for a given provider in a six (6) month period. As another example, a requestor might be limited to submitted only x reviews per day, week, month and/or year. There can be various implementations for the limitations which can use one or more of the limitation criteria (e.g., day, month, year) for general limitations or specific provider limitations. For example, a general limitation can limit requestors to at most four (4) reviews per day or seven (7) reviews per week, and a particular provider limitation can limit a requestor to only one review for a given provider in a six (6) month period. Limiting reviews in such a manner can assist in enhancing reliability of reviews and limit abusive reviews.

When the decision 508 determines that the review level is greater than the review limit, then the review request that is been submitted by the requestor can be denied 510. The requestor can be also notified 512 of the denial. The notification can be presented to the requestor via a computing device that the requestor has used to submit the new review request. The notification can be presented to the requestor via a text message, an in-app notification, or a web page. Following the notification 512, the review submission request process 500 can end.

Alternatively, when the decision 508 determines that the review level is not greater than the review limit, then the review submission request process 500 can continue to process the incoming review. In this regard, a review creation response can be formed 514. The review creation response can then be transmitted 516 to the requestor. Here, the review creation response is generated or acquired by the review server and serves to query the requestor for review criteria. Additionally, in one implementation, the review creation response can be transmitted 516 to the requestor by way of the requestor number (RN) that was extracted from the new review request. Doing so can serve to authenticate that it was indeed the requestor that initially submitted the new review request.

A decision 518 can then determine whether a review submission has been received. Here, a review submission can be received from the requestor in response to the review creation response. In other words, the requestor can interact or respond to the review creation response to create a review submission that serves to provide a review for the provider Identified by the PN. Depending on the implementation, the interaction can include a series of text messages, a series of selections of user controls, or completion of a web-based form.

When the decision 518 determines that a review submission has not yet been received, the review submission request process 500 can await such a submission. On the other hand, when the decision 518 determines that a review submission has been received, the review submission can be validated 520. The validation 520 can confirm that the requestor has properly responded to the review creation response. The validation can confirm that the review submission was from the same requestor number (RN) that initially made the new review request. The validation 520 can be performed in any of a variety of different ways. In one example, if the review submission is from a smart phone messaging application (app), the phone number of the smart phone should match the requestor number (RN) in order to be valid. In another example, if the review submission is from a network browser, the validation can use a session identifier provided by the review server with the review creation response and returned back to the review server with the review submission. In still another example, a PIN code could be texted to the requestor number (RN) and returned by requestor to validate requestor as actual submitter. The PIN code could be returned by text message.

Subsequently, a decision 522 can determine whether the review submission is deemed valid. When the decision 522 determines that the review submission is deemed not valid, the review submission can be denied 524. The requestor can also be notified 526 that the review submission has been denied. The notification can be presented to the requestor via a computing device that the requestor has used to submit the new review request. The notification can be presented to the requestor via a text message, an in-app notification, or a web page. Following the notification 526, the review submission request process 500 can end.

On the other hand, when the decision 522 determines that the review submission is valid, then further processing can be performed by the review submission request process 500 to process the review submission. In this regard, review data can be extracted 528 from the review submission. The review data can then be recorded 532 to a review database such that the review data corresponds to the provider corresponding to the provider number (PN). Additionally, the review level of the requestor (corresponding to the given provider) can be updated 532. Finally, the requestor can be notified 534 that the review has been successfully submitted. The notification can be presented to the requestor via a computing device that the requestor has used to submit the new review request. The notification can be presented to the requestor via a text message, an in-app notification, or a web page. Following the notification 534, the review submission request process 500 can end with a review having been successfully submitted.

In one embodiment, the review being submitted via the review submission request process 500 is rather simplified to facilitate user ease of use as well as efficient network transmission. In one implementation, a review can pertain to review data can pertain to a plurality of predetermined criterion, such as an overall rating, quality, efficiency, price, and whether recommended. In another implementation, a review can not only pertain to review data concerning a plurality of predetermined criterion but also a text (or narrative) portion.

FIG. 5C is a flow diagram of an additional process 500 according to one embodiment. The additional process 500 in one implementation can follow the block 534 so that the reviewer is able to provide additional review data, such as a text portion that can become part of the review.

The additional process 550 can access 552 a review narrative response. The review narrative response can then be transmitted 554 to the requestor. Here, the review narrative response is acquired from or generated by the review server and can serve to query the requestor for an additional text (or narrative) review. Additionally, in one implementation, the review narrative response can be transmitted 516 to the requestor by way of the requestor number (RN) that was extracted from the new review request. Doing so can insure that it was the same requestor that initially submitted the new review request completes the text portion.

Next, a decision 556 determines whether a narrative submission has been received. When the decision 556 determines that a narrative submission has not yet been received, the additional process 550 can await such a submission. On the other hand, when the decision 556 determines that a narrative submission has been received, the additional process 550 can continue with processing to process the narrative submission. In this regard, a decision 558 can determine whether a narrative was provided with the narrative submission. When the decision 558 determines that a narrative was provided with the narrative submission, then narrative data can be extracted 560 from the narrative submission. The narrative data can then be recorded 562 to the review database for the service provider. For example, the review data can then be recorded 562 to the review database such that the narrative data corresponds to the provider corresponding to the provider number (PN).

Following the recordation 562, the additional process 550 can end. Alternatively, if the decision 558 determines that a narrative was not provided with the narrative submission, the additional process 550 can end.

In one example, if the narrative submission is from a smart phone messaging application (app), the phone number of the smart phone should match the requestor number (RN) in order to be valid. In another example, if the narrative submission is from a network browser, the validation can use a session identifier provided by the review server with the review creation response and returned back to the review server with the narrative submission. In still another example, a PIN code could be texted to the requestor number (RN) and returned by requestor to validate requestor as actual submitter. The PIN code could be returned by text message.

Subsequently, a decision 522 can determine whether the review submission is deemed valid. When the decision 522 determines that the review submission is deemed not valid, the review submission can be denied 524. The requestor can also be notified 526 that the review submission has been denied. The notification can be presented to the requestor via a computing device that the requestor has used to submit the new review request. The notification can be presented to the requestor via a text message, an in-app notification, or a web page. Following the notification 526, the review submission request process 500 can end.

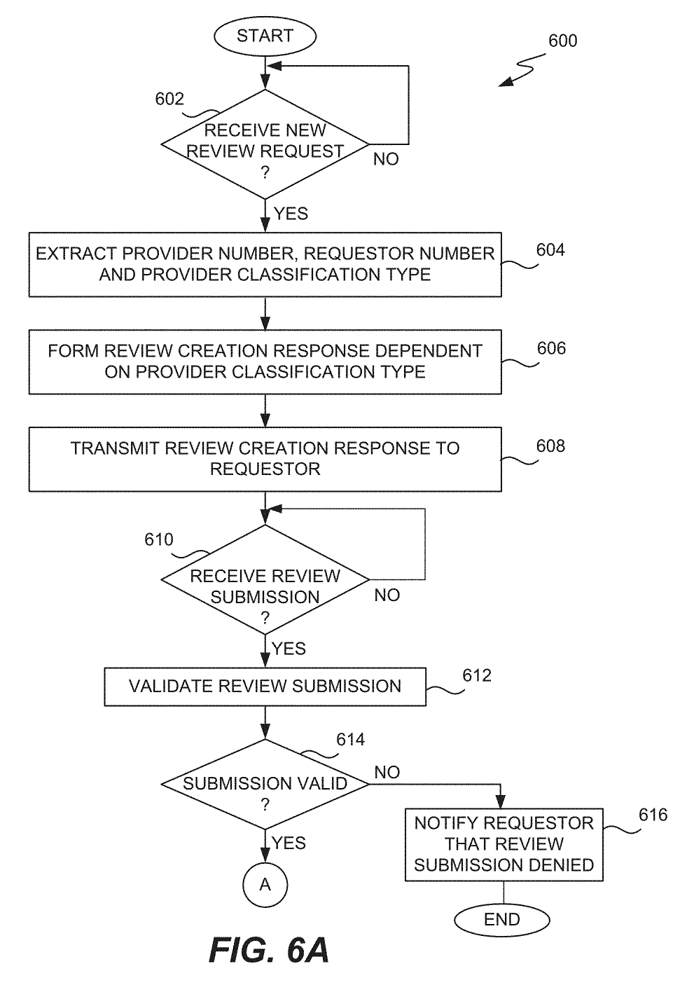

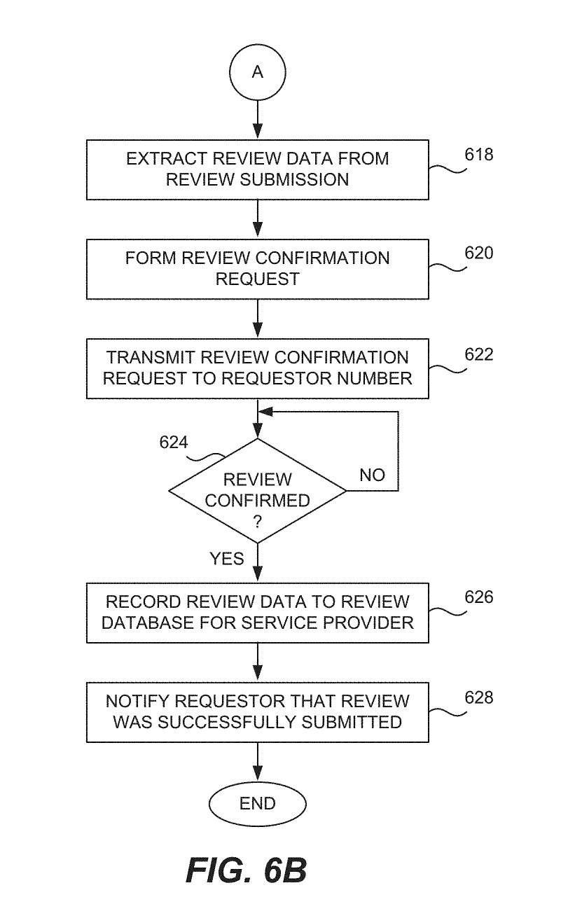

FIGS. 6A and 6B are flow diagrams of a review submission request process 600 according to one embodiment. The review submission request process 600 can, for example, be performed by a review server, such as the review server 102 illustrated in FIG. 1 or the review server 202 illustrated in FIG. 2.

The review submission request process 600 can begin with a decision 602 that determines whether a new review request has been received. When a reviewer submits a review, the review server considers the submission as a new review request. In any event, when the decision 602 determines that a new review request has not been received, the review submission request process 600 can await of such a request.

On the other hand, when the decision 602 determines that a new review request has been received, the review submission request process 600 can continue to perform processing to process the in-take of a review. When the review submission request process 600 continues, a provider number (PN), a requestor number (RN) and a service type can be extracted 604 from the new review request.

Next, a review creation response can be formed 606 dependent upon the service type. In this embodiment, the review creation response can be dependent on the service type. For example, the review creation response can be different for different types of service providers. The review creation response can then be transmitted 608 to the requester. Here, the review creation response is generated or acquired by the review server and is presented to the requestor (reviewer) and serves to query the requestor for review criteria.

A decision 610 can then determine whether a review submission has been received. Here, a review submission can be received from the requestor in response to the review creation response. In other words, the requestor can interact or respond to the review creation response to create a review submission that serves to provide a review for the provider identified by the provider number (PN). Depending on the implementation, the interaction can include a series of text messages, a series of selections of user interface controls, or completion of a web-based form.

When the decision 610 determines that a review submission is not yet been received, the review submission request process 600 can await such a submission. On the other hand, when the decision 610 determines that a review submission has been received, the review submission can be validated 612. The validation 612 can be implemented to provide validation in any one or more of a variety of ways. The validation 612 can confirm that the requestor has properly responded to the review creation response. The validation 612 can confirm that the review submission was from the same requestor number (RN) that initially made the new review request. In one example, if the review submission is from a smart phone messaging application (app), the phone number of the smart phone should match the requestor number (RN) in order to be valid. In another example, if the review submission is from a network browser, the validation can use a session identifier provided by the review server with the review creation response and returned back to the review server with the review submission. In still another example, a PIN code could be texted to the requestor number (RN) and returned by requestor to validate requestor as actual submitter.

Subsequently, a decision 614 can determine whether the review submission is deemed valid. When the decision 614 determines that the review submission is deemed not valid, the review submission can be denied and the requestor can be notified 616 that the review submission has been denied. The notification can, for example, be presented to the requestor via a computing device that the requestor has used to submit the new review request. The notification can be presented to the requestor via a text message, an in-app notification, or a web page. Following the notification 626, the review submission request process 600 can end.

On the other hand, when the decision 614 determines that the review submission response is valid, then further processing can be performed by the review submission request process 600 to process the review submission. In this regard, review data can be extracted 618 from the review submission.

Next, a review confirmation request can be formed 620. The review confirmation request can then be transmitted 622 to requestor number (RN). The review confirmation request can transmit a proposed review back to the requestor to permit the requestor to again review his/her review and confirm that they wish to submit it. Following the transmission 622 of the review confirmation request, a decision 624 can determine whether the review has been confirmed. If the decision 624 determines that the review has not yet been confirmed, then the review submission request 600 can await confirmation. Of course, eventually, if the review is not confirmed or if canceled, then the review submission request can end with no review being submitted.

After the review has been confirmed, the review can be formally submitted. In this regard, the review data can be recorded 626 in a review database such that the review data corresponds to the provider corresponding to the provider number (PN). Additionally, the requestor can be notified 628 that the review has been successfully submitted. The notification 628 can, for example, be presented to the requestor via a computing device that the requestor has used to submit the new review request. The notification can be presented to the requestor via a text message, an in-app notification, or a web page. Following the notification 628, the review submission request process 600 can end with a review having been successfully submitted.

In one embodiment, the review being submitted via the review submission request process 600 is rather simplified to facilitate user ease of use as well as efficient network transmission. In one implementation, a review can pertain to review data which can pertain to a plurality of predetermined criterion, such as an overall rating, quality, efficiency, price, and whether recommended. In another implementation, a review can not only pertain to review data concerning a plurality of predetermined criterion but also a text (or narrative) portion. The reviewer can provide (e.g., input) text to form a text portion of a review. The text portion can be limited to be a short message (e.g., limited to 255 characters).

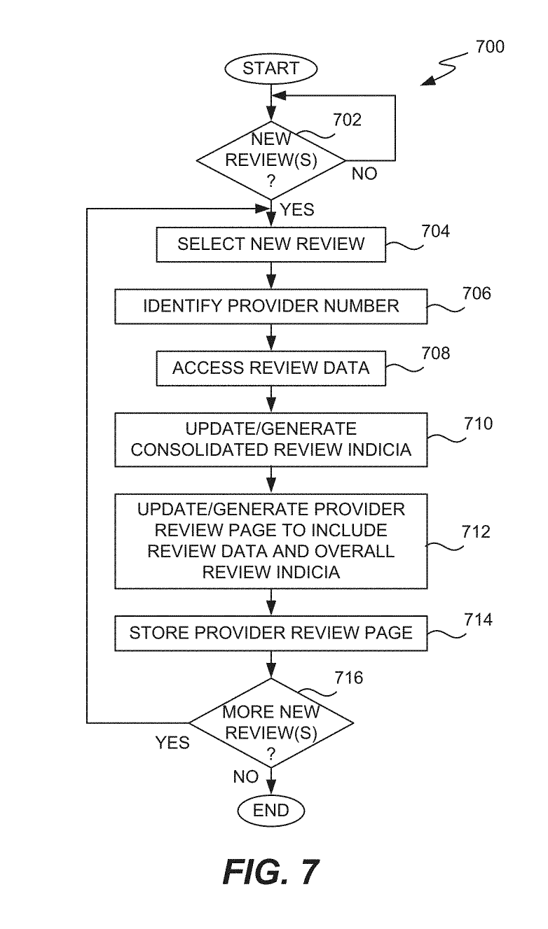

FIG. 7 is a flow diagram of a provider review page generation process 700 according to one embodiment. The provider review page generation process 700 can be performed by a review server such as the review server 102 illustrated in FIG. 1 or the review server 202 illustrated in FIG. 2. Typically, the provider review page generation process 700 would operate on a periodic basis, such as hourly or daily.

The provider review page generation process 700 can begin with a decision 702 that determines whether one or more new reviews are present. In one implementation, a data structure can be utilized to maintain a list of new reviews. As an example, the data structure can be implemented as a table in the review database, such as the new review table 306 of the database layout structure 300 illustrated in FIG. 3. The data structure can identify those one or more new reviews. When the decision 702 determines that there are no new reviews, the provider review page generation process 700 can be deferred to a later point in time when new reviews are present. In any event, when the decision 702 determines that there are one or more new reviews, the provider review page generation process 700 performs processing to generate or update a provider review page. The resulting provider review page can be stored, for example, in the provider review page store 106 illustrated in FIG. 1 or the provider review store 206 illustrated in FIG. 2.

The processing to generate or update a provider review page can initially select 704 a new review. In one implementation, the new review table 306 of the database layout structure 300 illustrated in FIG. 3 can be used to identify those new reviews to be processed. After the new review has been selected 704, the provider number (PN) can be identified 706. The review data pertaining to the new review can also be accessed 708. Again, the database layout structure 300 can be utilized to obtain the provider number (PN) as well as review data pertaining to the selected new review. As an example, the provider number can be obtained from the provider table 302, and the review data can be obtained from the review table 304.

Next, consolidated review indicia pertaining to the corresponding provider can be updated and/or generated 710. For example, consolidated review indicia can pertain to a star rating (e.g., 1-5 stars) associated with the provider and/or a recommended value (e.g., percentage of customers that would recommend provider). A provider review page can then be updated and/or generated 712 to include review data (from the new review along with prior reviews) and the consolidated review indicia. The resulting provider review page can then be stored 714. For example, the provider review page can be stored 714 to the provider review page store 106 or the provider review page store 206.

Thereafter, a decision 716 can determine whether there are more new reviews to be processed. When the decision 716 determines that there are still more new reviews to be processed, the provider page generation process 700 can return to repeat the block 704 and subsequent blocks so that an additional provider review page can be generated and stored. Alternatively, when the decision 716 determines that there are no more new reviews, the provider review page generation process 700 can end.

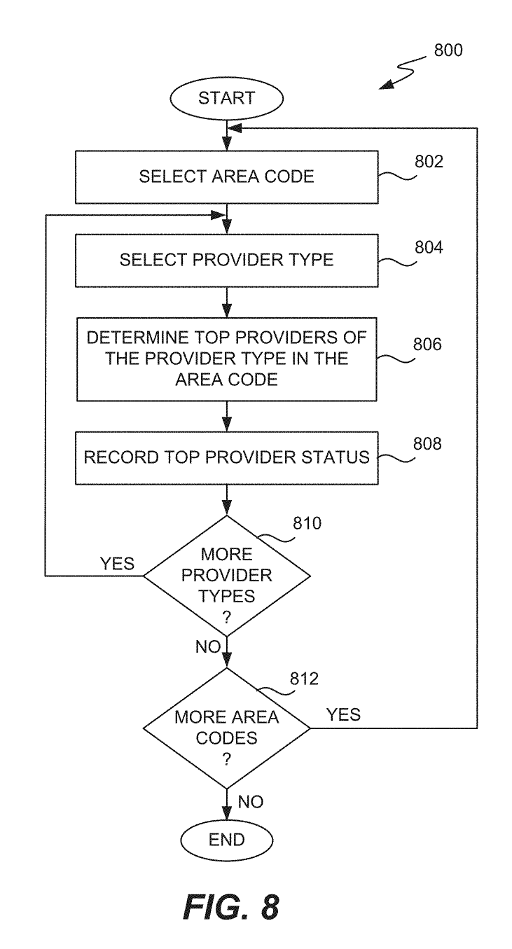

FIG. 8 is a flow diagram of a top provider process 800 according to one embodiment. The top provider process 800 can be performed by a review server such as the review server 102 illustrated in FIG. 1 or the review server 202 illustrated in FIG. 2. Typically, the top provider process 800 would operate on a periodic basis such as daily or weekly.

The top provider process 800 can begin with a selection 802 of an area code. The area code is used to define a geographic region. Then, a provider type can be selected 804. The provider type, as noted above, can pertain to a categorization of providers. In one implementation, the provider type can be selected 804 from a graphical user interface that provides a list of selectable different provider types. After the provider type has been selected 804, the top provider process 800 can determine 806 top providers of the selected provider type in the selected area code. This determination 806 can be based on one or more different criteria depending upon implementation. Typically, the determination 806 would utilize review data that is associated with the various providers maintained in the review database that are associated with the selected area code as well as provide services of the selected provider type. Then, the top provider status can be recorded 808 for those providers that are determined 806 to be the top providers of the selected provider type in the selected area code.

Next, a decision 810 can determine whether there are more provider types to be processed. When the decision 810 determines that there are more provider types be processed, the top provider process 800 returns to repeat the block 804 and subsequent blocks so that another provider type can be selected 804 and similarly processed. After all the prior provider types have been processed (i.e., the decision 810 determines that there are no more provider types to be processed), a decision 812 can determine whether there are more area codes to be processed. When the decision 812 determines that there are more area codes to be processed, the top provider process 800 can return to repeat the block 802 and subsequent blocks so that the additional area codes can be selected 802 and similarly processed. On the other hand, when the decision 812 determines that there are no more area codes to be processed, the top provider process 800 can end.

In one embodiment, a standard review can be made using a standard structure and text message interface. However, a reviewer whom submitted the standard review can be offered an opportunity to upgrade the standard review to an enhanced review. As one example, upon receiving submission of a standard review for a given provider, the reviewer can be sent another text message (or email message) that contains an opportunity to upgrade the standard review to an enhanced review which permits the reviewer to provide a narrative. For example, the reviewer can be provided with a text box that allows for entry of text. In one embodiment, the upgrade of the standard review to the upgraded review is permitted after payment of a fee.

A user interface can be provided at a customers or client devices, such as the customer or client devices 110, 112 illustrated in FIG. 1 or the customer or client devices 212 illustrated in FIG. 2. In one embodiment, the user interface provides a plurality of text message interfaces. In another embodiment, the user interface is a graphical user interface that is presented at the client device via a web browser presenting a webpage or via an application program operating on the client device.

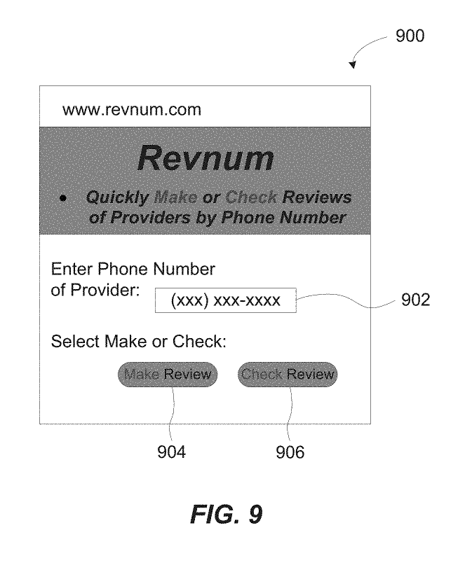

FIGS. 9-12 are exemplary screens of user interfaces for a provider review system according to one embodiment.

FIG. 9 is an exemplary screen of a base review user interface 900. The base review user interface 900 is a screen that can be presented to a potential reviewer desirous of either making a review for a provider or checking reviews previously submitted for a provider. The base review user interface 900 includes a phone number entry box 902 for which the potential reviewer can enter a phone number for a provider. Then, by selecting a Make Review user control 904, the potential reviewer can request a review form such that the potential reviewer can prepare a review for the provider denoted by the entered phone number entered in the phone number entry box 902. Alternatively, by selecting a Check Review user control 906, the potential reviewer can request a set of prior reviews for the provider denoted by the entered phone number entered in the phone number entry box 902.

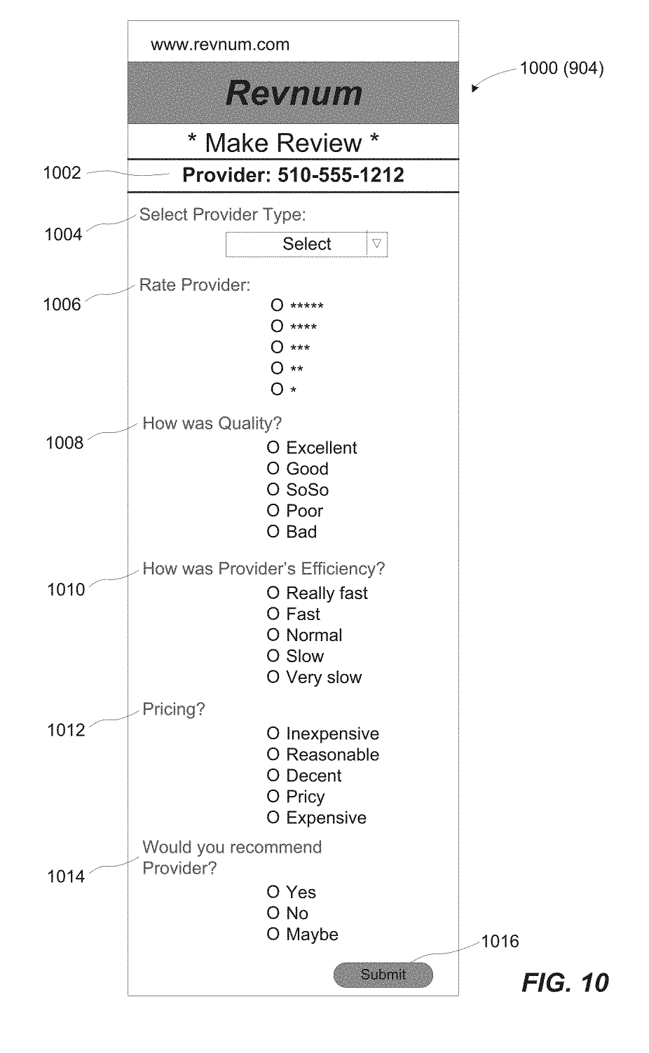

FIG. 10 is an exemplary screen of a make review user interface 1000. The make review user interface 1000 is a screen that can be presented to a reviewer desirous of either making a review for a provider. The provider being reviewed can be identified in a provider identification portion 1002. For example, the provider can be identified by a phone number. The make review user interface 1000 can include a provider type selector 1004 that allows the reviewer to identify a provider type, such as a classification of the type of goods or services provided by the provider. A few examples are contractor, attorney, advisor, consultant, hair stylist, car repair, etc. For the identified provider, the make review user interface 1000 can identify criterion for a review. In the make review user interface 1000, the criterion for a review includes a provider rating 1006, provider's quality 1008, provider's efficiency 1010, and provider's pricing 1012. The make review user interface 1000 can also include a recommendation portion 1014 where the review can denote whether they would recommend others to user the provider or not. The provider rating 1006 selections can be star “*” ratings. The provider's quality 1008 selections can be excellent, good, soso, poor and bad. The provider's efficiency 1010 selections can include really fast, fast, normal, slow and very slow. The provider's pricing 1012 selections can include inexpensive, reasonable, decent, pricy and expensive. The recommendation portion 1014 can also offer selections, such as yes, no and maybe.

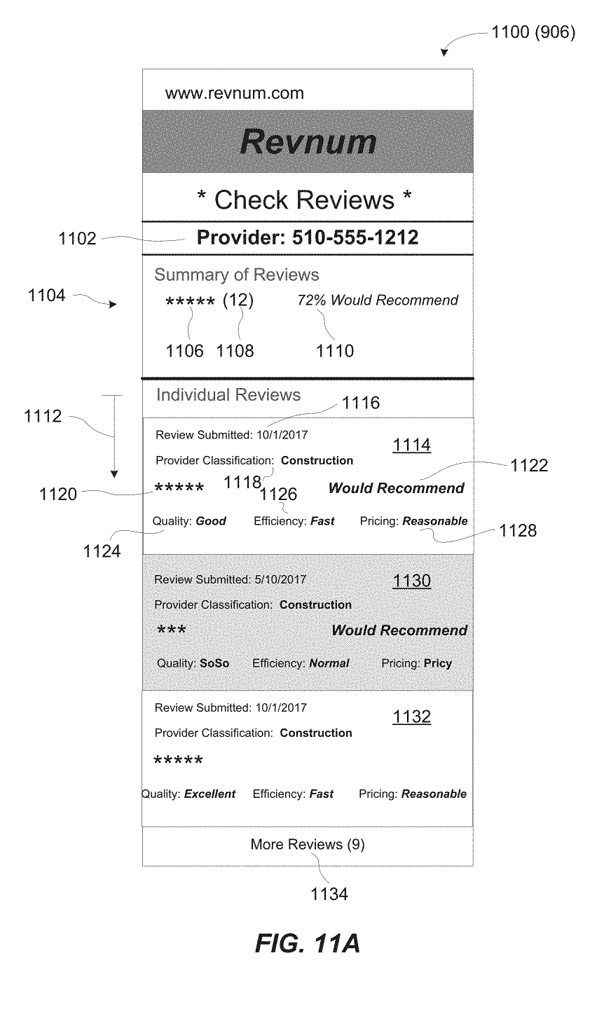

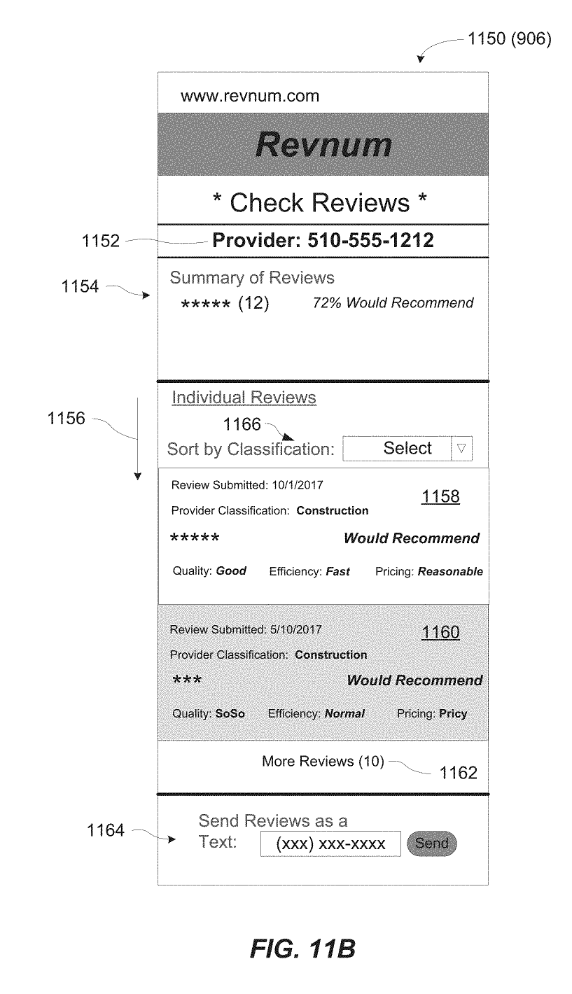

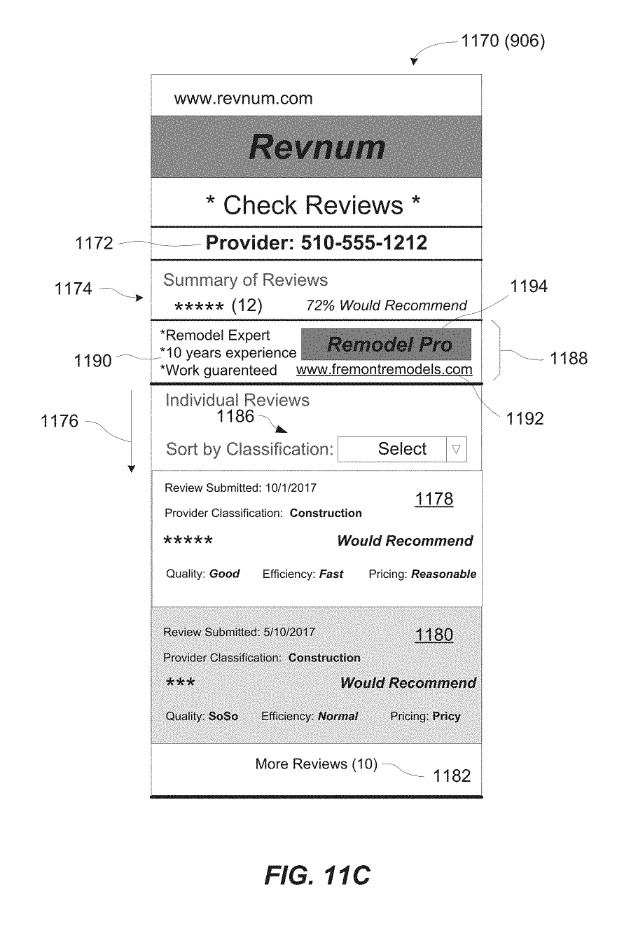

FIG. 11A is an exemplary screen of a provider review user interface 1100. The provider review user interface 1100 is a screen that can be presented to a potential client interested in reviewing reviews of providers. The provider associated with the reviews can be identified in a provider identification portion 1102. For example, the provider can be identified by a phone number. The provider review user interface 1100 can include a summary of reviews portion 1104. In one implementation, the summary of reviews portion 1104 can include (i) an aggregate rating 1106 for the provider across a plurality of review for that provider; (ii) a numeric indicator 1108 of the number of reviews for that provider; and (iii) an aggregate recommendation percentage 1110. Additionally, the provider review user interface 1100 can include an individual reviews portion 1112 that provides review data from a plurality of distinct reviews for the provider. For example, review data 1114 for a most recent review for the provider can be at the top of the individual reviews portion 1112, followed by review data for the next most recent review for the provider, etc. The review data 1114 can, for example, include a review submission date 1116, a provider classification 1118, an overall star rating 1120, whether or not recommended 1122, quality rating 1124, efficiency 1126 and pricing 1128. The provider review user interface 1100 also presents review data 1130 for a second most recent review, followed by review data 1132 for a third most recent review. The provider review user interface 1100 can also display a more reviews control 1134 to denote availability of additional review data, which can be present upon selection of the more reviews control 1134.

FIG. 11B is another exemplary screen of a provider review user interface 1150. The provider review user interface 1150 is a screen that can be presented to a potential client interested in reviewing reviews of providers. The provider associated with the reviews can be identified in a provider identification portion 1152. For example, the provider can be identified by a phone number. The provider review user interface 1150 can include a summary of reviews portion 1154. In one implementation, the summary of reviews portion 1104 can include (i) an aggregate rating for the provider across a plurality of review for that provider; (ii) a numeric indicator of the number of reviews for that provider; and (iii) an aggregate recommendation percentage. Additionally, the provider review user interface 1150 can include an individual reviews portion 1156 that provides review data from a plurality of distinct reviews for the provider. For example, review data 1158 for a most recent review for the provider can be at the top of the individual reviews portion 1156, followed by review data 1160 for the next most recent review for the provider, etc. The review data 1158 can, for example, include a review submission date, a provider classification, an overall star rating, whether or not recommended, quality rating, efficiency and pricing. The provider review user interface 1150 can also display a more reviews control 1162 to denote availability of additional review data, which can be present upon selection of the more reviews control 1162. Still further, the provider review user interface 1150 can include a display control tool 1166 that allows reviews for a given provided to be sorted or filtered based on provider classification (e.g., job type). Examples of classification are construction, plumbing, electrician, attorney, architect, cleaner, painter, photographer, etc. Hence, to the extent that a given provider has reviews for more than one classification, the display control tool 1166 can be used to cause the review for a selected classification to be display (first or exclusively). In one example, the display control tool 1166 can be implemented as a drop-down selection from available classification types (from reviews of the given provider). In another example, the display control tool 1166 can be implemented as a plurality of selectable tabs pertaining to available classification types (from reviews of the given provider), and selection of a tab selects from available classification types.

Optionally, the provider review user interface 1150 can include a send text request control 1164. The send text control 1164 can be presented to enable a reviewer to cause the reviews for the service provider to be sent to an entered phone number.

FIG. 11C is yet another exemplary screen of a provider review user interface 1170. The provider review user interface 1170 is a screen that can be presented to a potential client interested in reviewing reviews of providers. The provider associated with the reviews can be identified in a provider identification portion 1172. For example, the provider can be identified by a phone number. The provider review user interface 1170 can include a summary of reviews portion 1174. In one implementation, the summary of reviews portion 1174 can include (i) an aggregate rating for the provider across a plurality of review for that provider; (ii) a numeric indicator of the number of reviews for that provider; and (iii) an aggregate recommendation percentage. Additionally, the provider review user interface 1170 can include an individual reviews portion 1176 that provides review data from a plurality of distinct reviews for the provider. For example, review data 1178 for a most recent review for the provider can be at the top of the individual reviews portion 1176, followed by review data 1180 for the next most recent review for the provider, etc. The review data 1178 can, for example, include a review submission date, a provider classification, an overall star rating, whether or not recommended, quality rating, efficiency and pricing. The provider review user interface 1170 can also display a more reviews control 1182 to denote availability of additional review data, which can be present upon selection of the more reviews control 1182. Still further, the provider review user interface 1170 can include a display control tool 1186 that allows review for a given provided to be sorted or filtered based on provider classification (e.g., job type). Examples of classification are construction, plumbing, electrician, attorney, architect, cleaner, painter, photographer, etc. Hence, to the extent that a given provider has reviews for more than one classification, the display control tool 1186 can be used to cause the review for a selected classification to be display (first or exclusively). In one example, the display control tool 1186 can be implemented as a drop-down selection from available classification types (from reviews of the given provider). In another example, the display control tool 1186 can be implemented as a plurality of selectable tabs pertaining to available classification types (from reviews of the given provider), and selection of a tab selects from available classification types. In addition, the provider review user interface 1170 can also include provider data 1188. The provider data 1188 can include text 1190, a hyperlink 1192 and/or a logo 1194, all of which is associated with the provider 1194. The provider data 1188 can be provided by the provider so that the provider can describe his or her business (e.g., service provided, awards, certification, marketing, sales), a logo, and contact information (website address or phone).

The provider data 1188 can be provided by a provider using a user interface. The user interface can, for example, be a web page or part of an application program. A provider can interact with the user interface to input or select the provider data 1188. The provider data 1188 can be stored in the review database.

In one embodiment, the review data captured for a given review is restricted to selection of predetermined choices. The exemplary screens in FIGS. 11A-11C are such implementations. However, in another embodiment, a provider review user interface can include a text box that permits a reviewer to enter comments pertaining to the provider. In one implementation, the text comments are part of the reviewer's review and can be provided in addition to predetermined standardized selections of predetermined choices. There can be a limit on the amount of text comments permitted, such as a character limited (e.g., to 100, 150 or 250 characters).

In one embodiment, if a review includes text comments or other possible enhancements, there might be a fee for doing so. If a reviewer submits a standardized review from selections of predetermined choices, that a review server can facilitate offering the reviewer an option to include text comment (or other enhancements) with their review, for which there might be a nominal fee. This offer could be provided by the review server proximate in time to the standard review submission by the reviewer, or could be provided by a follow-up text message providing the offer. The follow-up text message could include a network link to a webpage where the reviewer can enter the text comments (or select other enhancements). Alternatively, the text comments could be provided in a reply text message.

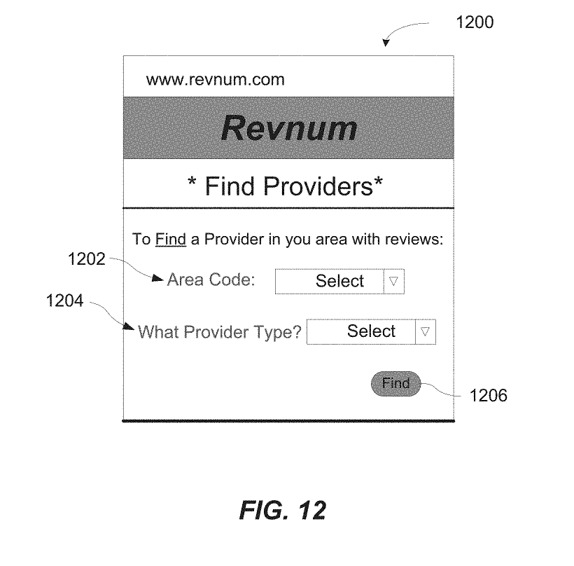

FIG. 12 is an exemplary screen of a provider find user interface 1200. The provider find user interface 1200 is a screen that can be presented to a potential client (user) interested in finding or searching for providers. The provider find user interface 1200 can include an area code selection control 1202 and a provider type selection control 1204. The area code selection control 1202 allows the potential client to enter or select an area code for identification of their geographic area of interest. The provider type selection control 1204 allows the potential client to enter or select a classification (or job type) to denote the type of provider they are searching for. A find control 1206 can be selected to initiate the find request. A server can receive and process the find request and return information of previously reviewed providers that correspond to the selections. It is not necessary for exact matches. Related or adjacent area codes can be considered acceptable.

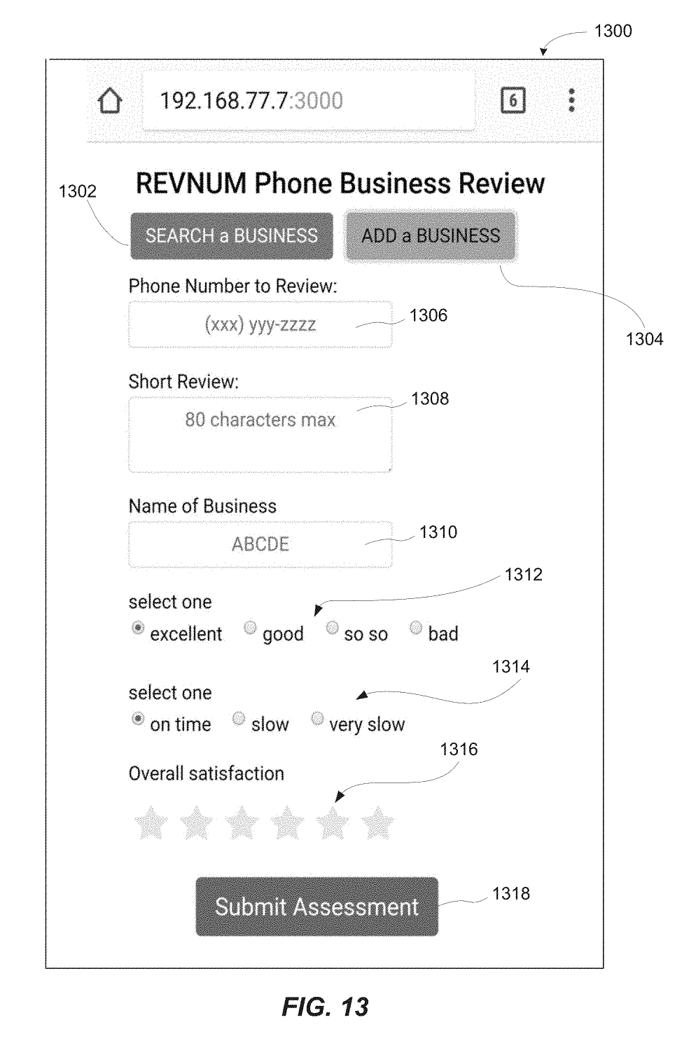

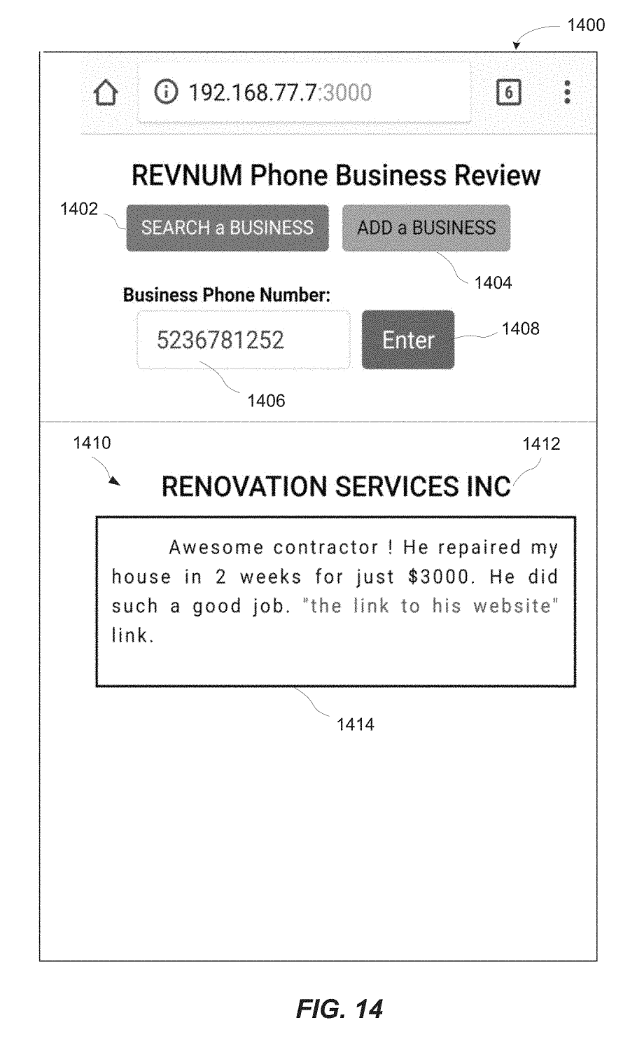

FIGS. 13 and 14 are exemplary screen shots of a user interface according to one embodiment.

FIG. 13 is an exemplary screen of a business review user interface 1300. The business review user interface 1300 is a screen that can be presented to a potential client interested in making a review for a business. The business review user interface 1300 can include a UI control 1302 to search for a business, and a UI control 1304 to add a business. The business review user interface 1300 can also include a text box 1306 to receive a phone number for the business being reviewed; a text box 1308 for entry of a short review (narrative); a text box 1310 to receive the business name; a selection control 1312 to select a characteristic (e.g., quality); and a selection control 1314 to select overall satisfaction. The business review user interface 1300 can also include a submit assessment button 1318 to submit the review.

FIG. 14 is an exemplary screen of a business review user interface 1400. The business review user interface 1400 is a screen that can be presented to a potential client interested in reading prior reviews for a business. The business review user interface 1400 can include a UI control 1402 to search for a business, and a UI control 1404 to add a business. The business review user interface 1400 can also include a text box 1406 to receive a phone number for the business being reviewed, and a enter button 1408 to send a request for the relevant review information. The returned review information (e.g., from a remote network-connected server) can be displayed in a review area 1410 of the business review user interface 1400. The review area 1410 can list one or more assessments of the provider (e.g., business) from reviewers. These one or more assessments displayed in the review area 1410 are associated with the phone number for the business provided in text box 1406. As shown in FIG. 14, in one implementation, the review area 1410 can include a business name 1412 and text comments 1414. The text comments 1414 can form all or part of an assessment of the business by the reviewer.

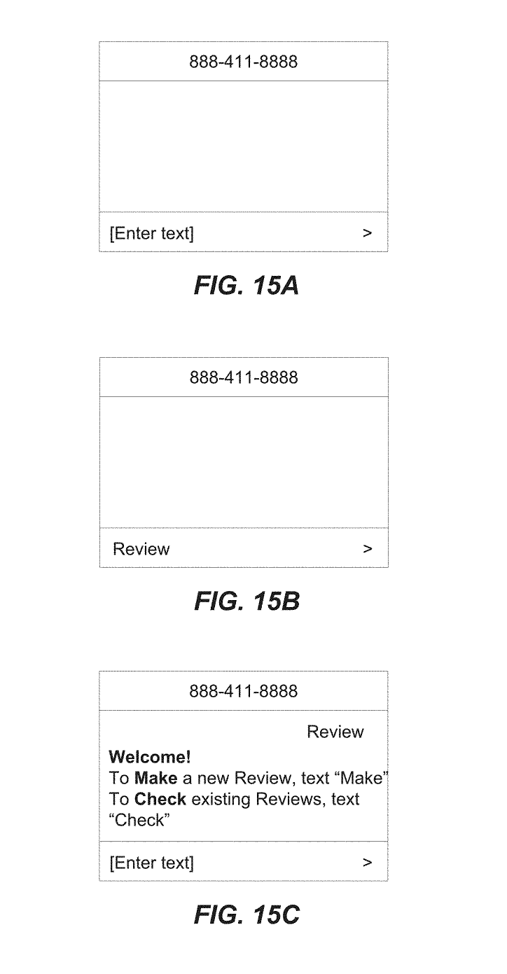

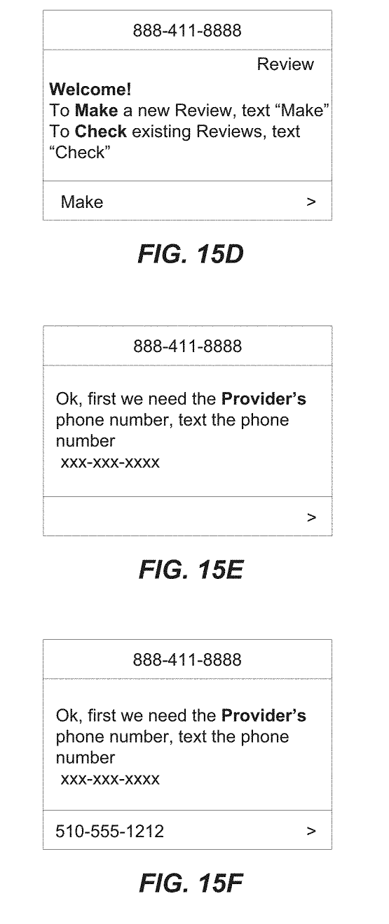

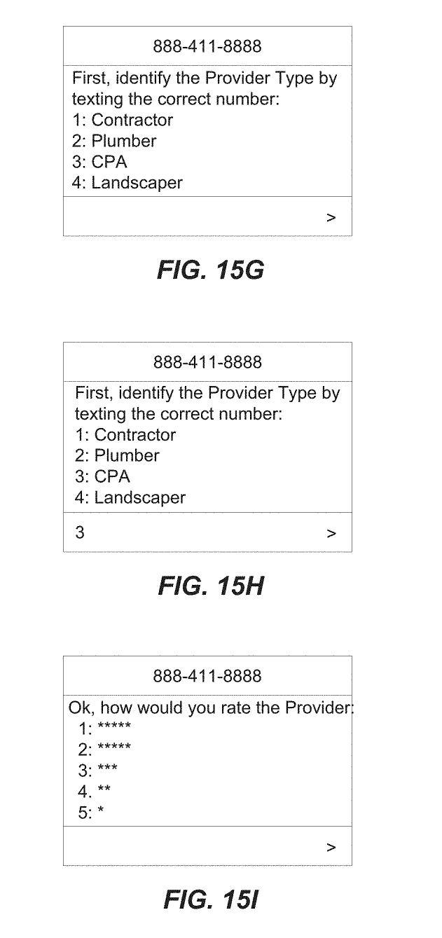

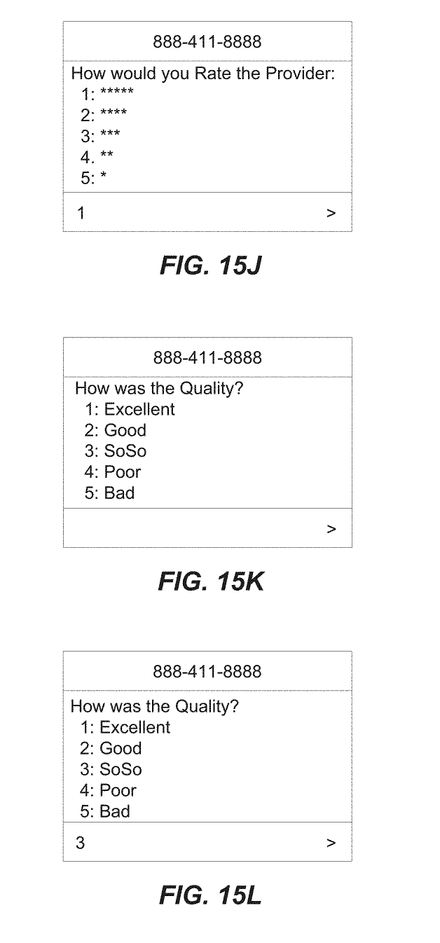

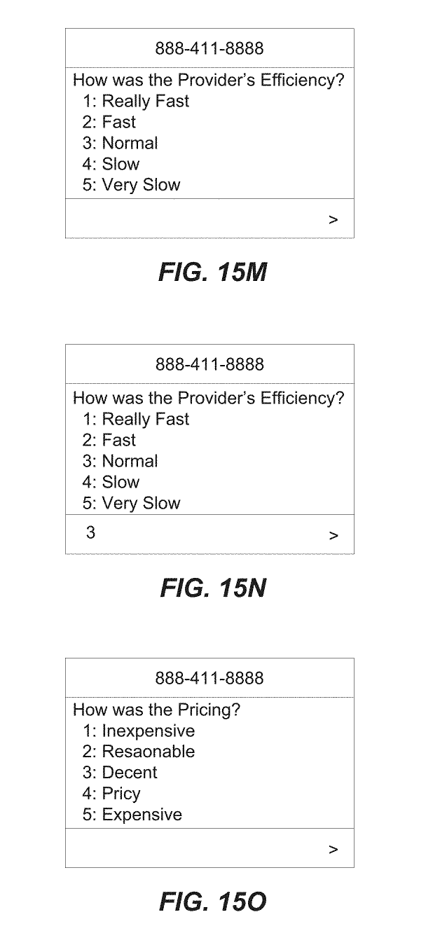

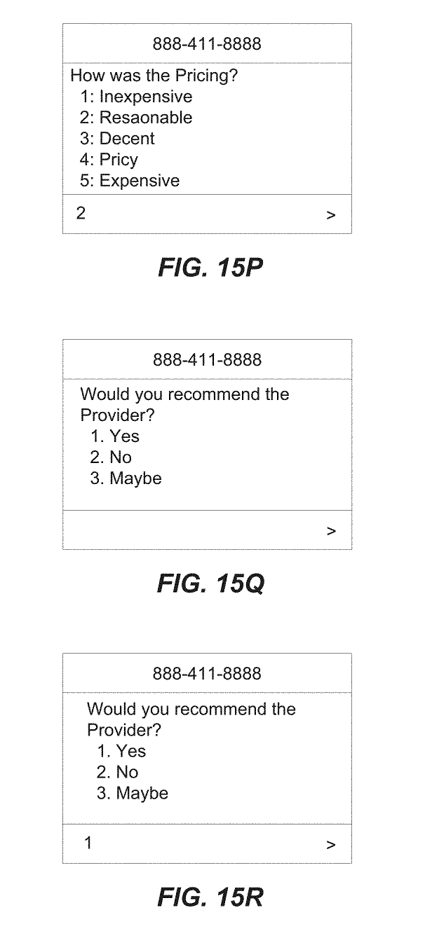

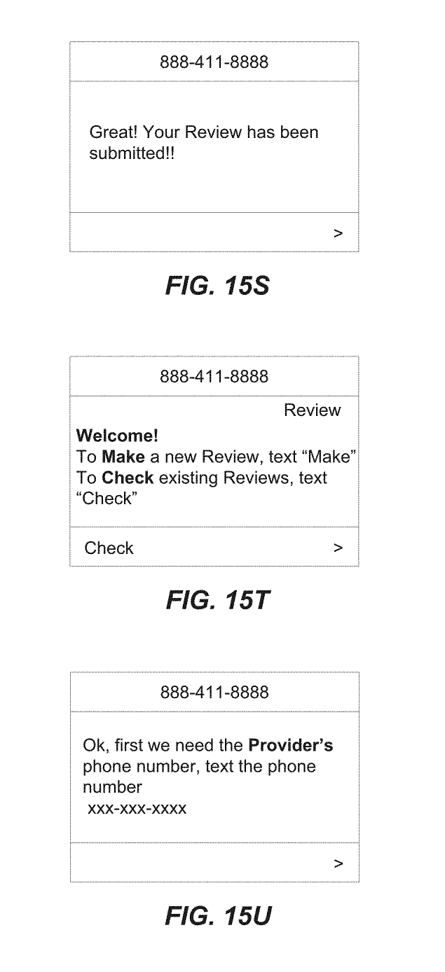

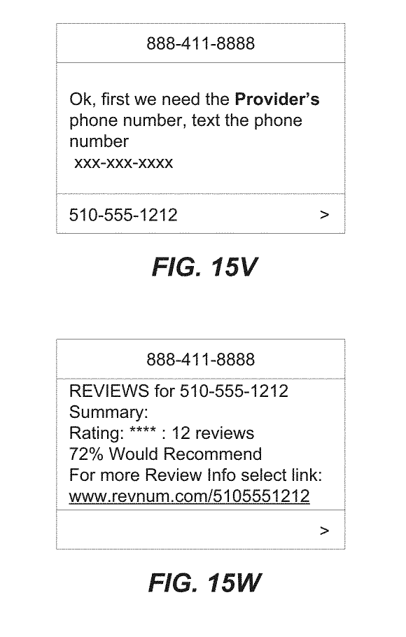

FIGS. 15A-15W are exemplary screens of text-messages providing user interfaces for a provider review system according to certain embodiments. FIGS. 15A-15C are exemplary initial text screens for initially communicating with the provider review system. FIGS. 15D-15S are exemplary initial text screens for providing multi-step user interaction with the provider review screen to allowing a reviewer to submit a review for a provider. FIGS. 15T-15W are exemplary initial text screens for providing multi-step user interaction with the provider review screen to allowing an interested person to access review information for a provider.

FIGS. 15A and 15B illustrate initial text screens that establish a text chat session with a provider review gateway in communication with a review server. In this example, a reviewer/interested party send a “review” text to a phone number [e.g., 888-411-8888] associated with the provider review gateway. FIG. 15C illustrates a welcome text screen that follows the text screen of FIG. 15B. The welcome text screen can allow a reviewer to initiate a Make review process to submit a review. The welcome text screen can also allow an interested party to initiate a Check review process to access reviews of a provider.

FIGS. 15D-15S are exemplary initial text screens for providing multi-step user interaction with the provider review screen to allowing a reviewer to submit a review for a provider.

FIG. 15D illustrates the welcome text screen of FIG. 15C after the reviewer has entered “Make” into a text entry box. The text message is then sent. In response, FIG. 15E illustrates a provider identification screen. The reviewer can interact with the provider identification screen to provide the phone number for the provider to be reviewed. FIG. 15F illustrates the provider identification screen after the reviewer has entered the provider's phone number (e.g., “510-555-1212”).

In response to submission of the provider's phone number via the provider identification screen, FIG. 15G illustrates a provider type identification screen. The provider type identification screen which solicits an input of a provider type for the provider being reviewed. FIG. 15H illustrates the provider type identification screen after the reviewer has entered an identification of a provider's type.

In response to submission of the provider's type via the provider type identification screen, FIG. 15I illustrates a provider rating screen. The provider rating screen which solicits an input of a rating for the provider being reviewed. For example, the rating can be a star rating, such as from one star to five stars (with five stars being the highest rating). FIG. 15J illustrates the provider rating screen after the reviewer has entered an indication of a rating for the provider.

In response to submission of the provider's rating via the provider rating screen, FIG. 15K illustrates a provider quality screen. The provider quality screen which solicits an input of a quality indication for the provider being reviewed. FIG. 15L illustrates the provider quality screen after the reviewer has entered the quality indication for the provider.

In response to submission of the provider's quality indication via the provider quality screen, FIG. 15M illustrates a provider efficiency screen. The provider efficiency screen which solicits an input of an efficiency indication for the provider being reviewed. FIG. 15N illustrates the provider efficiency screen after the reviewer has entered the quality indication for the provider.

In response to submission of the provider's efficiency indication via the provider quality screen, FIG. 15O illustrates a provider pricing screen. The provider pricing screen which solicits an input of a pricing indication for the provider being reviewed. FIG. 15P illustrates the provider pricing screen after the reviewer has entered the pricing indication for the provider.

In response to submission of the provider's pricing indication via the provider pricing screen, FIG. 15Q illustrates a recommendation screen. The recommendation screen solicits an input of a recommendation of whether the reviewer would recommend to others the provider being reviewed. FIG. 15R illustrates the recommendation screen after the reviewer has entered the recommendation indication for the provider.

In response to submission of the recommendation indication via the recommendation screen, FIG. 15S illustrates a review completion screen. The review completion screen can indicate submission of the review and thank the reviewer for the review.

FIGS. 15T-15W are exemplary initial text screens for providing multi-step user interaction with the provider review screen to allowing an interested person to access review information for a provider.

FIG. 15T illustrates the welcome text screen of FIG. 15C after the interested person has entered “Check” into a text entry box. The text message is then sent. In response, FIG. 15U illustrates a provider identification screen. The interested person can interact with the provider identification screen to provide the phone number for the provider to be reviewed. FIG. 15V illustrates the provider identification screen after the interested person has entered the provider's phone number (e.g., “510-555-1212”).

In response to submission of the provider's phone number via the provider identification screen, FIG. 15W illustrates a provider review screen. The provider review screen displays review information for the provider corresponding to the provider's phone number. In one implementation, the review information can include summary review data, such as an average rating (e.g., star rating), total number of reviews for the provider, and percentage of reviews that recommend the provider. The review information can also include a selectable link which on selection can allow the interested person to access additional review data. The selectable link can, for example, be to a web page detailing review information for the provider.

In one embodiment, the review criteria could be denoted by descriptive words, such as those in FIGS. 10 and 15I-15P. In another embodiment, some or all of the review criteria could be denoted by graphical representations, with or without descriptive words. For example, provider's efficiency could be animal graphics, such as a turtle representing a very slow provider and a rabbit representing a fast provider, and a greyhound representing a very fast provider.

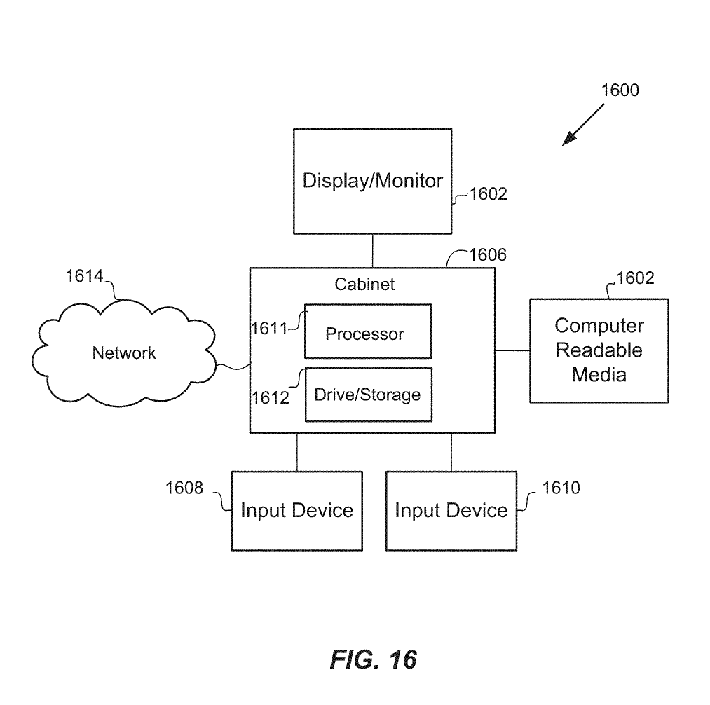

FIG. 16 shows an exemplary computer system 1600. One or more of the exemplary computer systems are suitable for use with at least one embodiment of the invention. The computer system 1600 includes a display/monitor 1602 having a single or multi-screen display, touch screen, (or multiple displays), a cabinet 1606, an input device 1608 (e.g., keyboard), input device 1610 (e.g., a mouse, input surface, buttons, speakers, controller, etc. The cabinet 1606 houses the computer system. The cabinet 1606 can, for example, be the casing of a smart phone, a laptop, a tablet, a desktop computer, a server computer, etc. The cabinet 1606 can also house drive(s)/storage 1612 (e.g., such as a CD-ROM, system memory, and a mass storage device (e.g., hard drive or solid-state drive), etc.), which may be utilized to store retrievable software programs incorporating computer code that implements an embodiment of the invention, data for use with embodiment(s) of the invention, and the like. Other exemplary computer readable medium may include computer readable digital video, audio, including floppy disk, tape, flash memory, system memory, and hard drive may be utilized. The cabinet 1606 may also house a processor 1611, which is used to process operations for carrying out one or more operations described herein. The processor can also enable communication of data with a network 1614. The network may be, for example, a local area network, a wide area network, or the Internet.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for processing a review request for storage in a database, the method comprising:
receiving a review request from a reviewer, the reviewer having a reviewer phone number associated with the reviewer, the review request including a provider phone number associated with a provider;
extracting the reviewer phone number and the provider phone number from the review request;
accessing the database to retrieve eligibility data for the reviewer with regard to the provider phone number;
determining whether the reviewer is eligible to review the provider associated with the provider phone number based on the eligibility data;
forming a review creation response for the reviewer if the determining determines that the reviewer is eligible to review the provider;
transmitting the review creation response to the reviewer;
subsequently receiving a review submission response from the reviewer, the review submission response being in response to the review creation response, the review submission response providing the review of the provider by the reviewer, and the review submission response including review data for the review; and
accessing the database to update the database to at least include the review data for the review of the provider by the reviewer.

2. A method as recited in claim 1, wherein the database associates the review of the provider to the provider phone number and also associates the review as provided by the reviewer.

3. A method as recited in claim 1, wherein the database associates the review of the provider to the provider phone number and also associates the review to the reviewer phone number.

4. A method as recited in claim 1, wherein the review data includes at least a provider classification and a plurality of feedback indications.

5. A method as recited in claim 1, wherein the method comprises:
notifying the reviewer that the review has been successively submitted; and
database associates the review of the provider to the provider phone number and also associates the review as provided by the reviewer.

6. A method as recited in claim 1, wherein the method comprises:
updating consolidated review indicia pertaining to the provider based on at least a portion of the review data for the review of the provider.

7. A method as recited in claim 1, wherein the method comprises:
determining whether the provider is a top provider for an area affiliated with the provider.

8. A method as recited in claim 1, wherein the transmitting of the review creation response and the subsequent receiving the review submission response are performed by a plurality of steps.

9. A method as recited in claim 8,
wherein each of the plurality of steps includes a text message,
wherein the transmitting of the review creation response to the reviewer is performed over a series of text messages, and
wherein the subsequently receiving the review submission response from the reviewer is performed over a series of text messages.

10. A method as recited in claim 1, wherein the method comprises:
validating the review submission response received,
wherein the validating is performed after the receiving the review submission response and before the accessing the database to update the database to at least include the review data for the review of the provider by the reviewer.

11. A method as recited in claim 10, wherein the validating confirms that the review submission response is provided by the reviewer having the reviewer phone number that initiated the review request.

12. A method for processing a review request for storage in a database, the method comprising:
receiving a review request from a reviewer, the reviewer having a reviewer phone number associated with the reviewer, the review request including (i) a provider phone number associated with a provider and (ii) a provider classification;
extracting the reviewer phone number, the provider phone number and the provider classification from the review request;
forming a review creation response for the reviewer dependent on the provider classification of the provider;
transmitting the review creation response to the reviewer;
subsequently receiving a review submission response from the reviewer, the review submission response being in response to the review creation response, the review submission response providing the review of the provider by the reviewer, and the review submission response including review data for the review; and
accessing the database to update the database to at least include the review data for the review of the provider by the reviewer.

13. A method as recited in claim 12, wherein the database associates the review of the provider to the provider phone number and also associates the review to the reviewer phone number.

14. A method as recited in claim 12, wherein the review data including at least a provider classification and a plurality of feedback indications.

15. A method as recited in claim 12, wherein the method comprises:
notifying the reviewer that the review has been successively submitted; and
database associates the review of the provider to the provider phone number and also associates the review as provided by the reviewer.

16. A method as recited in claim 12, wherein the method comprises:
accessing the database to retrieve eligibility data for the reviewer with regard to the provider phone number; and
determining whether the reviewer is eligible to review the provider associated with the provider phone number based on the eligibility data,
wherein the forming of the review creation response for the reviewer forms the review creation response if the determining determines that the reviewer is eligible to review the provider.

17. A method as recited in claim 12, wherein the method comprises:
offering the reviewer an opportunity to further include a text review for the provider; and
determining whether a text review submission has been received from the reviewer.

18. A method for accessing information pertaining to a service provider, said method comprising:
electronically receiving an inquiry submission from a requestor, the inquiry submission being initiated by the requestor via a network, the inquiry submission including a telephone number associated with a service provider;
accessing a provider database using the telephone number to retrieve access data for retrieval of provider review information pertaining to the service provider;
retrieving the provider review information pertaining to the service provider using the access data; and
electronically transmitting the provider review information to the requestor.

19. A method as recited in claim 18, wherein, prior to the receiving of the inquiry submission, the provider review information is stored in a data store, and the access data for retrieval of the provider review information is stored in the provider database.

20. A method as recited in claim 18, wherein the provider database includes a URL for a provider review webpage that pertains to the provider, and
wherein the electronically transmitting the response to the requestor comprises electronically transmitting an electronic message to the requestor that includes the URL for the provider review webpage.

21. A method as recited in claim 18, wherein the provider review information includes accumulated review data and individual review data.

22. A method as recited in claim 21, wherein the accumulated review data includes an overall recommendation indicator for the provider based on a plurality of previously submitted reviews concerning the provider from different requestors.
